(19) United States
(12) Patent Application Publication
(10) Pub. No.: US 2015/0256809 A1
(43) Pub. Date: Sep. 10, 2015

(54) METHOD FOR INDUCING DISPARITY VECTOR IN PREDICTING INTER-VIEW MOTION VECTOR IN 3D PICTURE

(71) Applicant: HUMAX HOLDINGS CO., LTD., Yongin (KR)

(72) Inventors: Alex Chungku Yie, Incheon (KR); Yong-Jae Lee, Seoul (KR); Hui Kim, Namyangju (KR)

(21) Appl. No.: 14/432,715

(22) PCT Filed: Oct. 21, 2013
(86) PCT No.: PCT/KR2013/009375

§ 371 Date: Mar. 31, 2015

(30) Foreign Application Priority Data
Oct. 22, 2012 (KR) 10-2012-0117011
Oct. 21, 2013 (KR) 10-2013-0125014

(51) Int. Cl. H04N 13/00; H04N 19/513

(52) U.S. Cl. CPC H04N 13/0048; H04N 19/513

(57) ABSTRACT

In a method for inducing a disparity vector in predicting an inter-view motion vector a 3D picture, the disparity vector is induced by adaptively searching a different number of depth samples within a block according to the size of a current block, for example, the size of a prediction unit, and then obtaining a maximum depth value. As a result, coding/decoding gain can be increased compared to a method for searching depth samples with respect to a fixed block size.

### BACKGROUND OF THE INVENTION

1. Field of the Invention

The present invention relates to methods and apparatuses for coding a 3D picture, and more particularly, to methods for inducting a disparity vector in predicting an inter-view motion vector in a 3D picture.

2. Related Art

A multi-view 3D TV has an advantage that since a 3D picture depending on the position of an observer can be viewed, a more natural 3D effect is provided, but a disadvantage that it is impossible to provide pictures of all views and large cost is required even in terms of transmission. Therefore, an intermediate view picture synthesizing technique that makes a picture for a view which does not exist by using a transmitted picture is required.

In the intermediate view picture synthesizing, a key core is disparity estimation that expresses a disparity as a disparity vector (DV) by obtaining a similarity of two pictures.

Meanwhile, In the case of a 3D picture, each pixel includes pixel information and depth information due to a characteristic of the picture, and an encoder may calculate the depth information or a depth map to transmit multi-view picture information and depth information to a decoder.

In this case, motion vector prediction is used. A motion vector of a neighboring block of a current prediction unit is used as a candidate block of a prediction motion vector and the 3D picture having the depth information requires a method for simply and efficiently inducting the disparity vector by using the depth information or the depth map.

### SUMMARY OF THE INVENTION

The present invention provides methods for inducing a disparity vector in predicting an inter-view motion vector in a 3D picture, which is used for reducing complexity at the time of inducing the disparity vector in predicting the inter-view motion vector of the 3D picture.

The present invention also provides method for inducing a disparity vector in predicting an inter-view motion vector in a 3D picture using the methods.

In one aspect, a method for inducing a disparity vector from a maximum depth value in a depth map associated with a current block in order to replace the unavailable inter-view motion vector when a target reference picture is an inter-view prediction picture at the time of predicting an inter-view motion vector in a 3D picture and an inter-view motion vector of neighboring blocks of the current block is unavailable, includes: inducing the disparity vector by obtaining the maximum depth value by searching a predetermined number of depth samples in the depth map associated with the current block with respect to the current block.

A maximum disparity vector may be induced by obtaining the maximum depth value by searching depth samples of four corners of respective 8×8-size blocks with respect to a 16×16 block size constituted by four 8×8-size blocks.

The maximum disparity vector may be induced by obtaining the maximum depth value by searching depth samples of four corners of respective 8×8-size blocks with respect to a 32×32 block size constituted by sixteen 8×8-size blocks.

In another aspect, a method for inducing a disparity vector from a maximum depth value in a depth map associated with a current block in order to replace the unavailable inter-view motion vector when a target reference picture is an inter-view prediction picture at the time of predicting an inter-view motion vector in a 3D picture and an inter-view motion vector of neighboring blocks of the current block is unavailable, includes: inducing the disparity vector by obtaining the maximum depth value by adaptively searching a different number of depth samples in the depth map associated with the current block according to the size of the current block.

A maximum disparity vector may be induced by obtaining the maximum depth value by adaptively searching only K (K is a positive integer) depth samples according to the size of a prediction unit (PU).

A maximum disparity vector may be induced by obtaining the maximum depth value by searching depth samples of four corners of respective 8×8-size blocks with respect to a 16×16 block size constituted by four 8×8-size blocks.

The maximum disparity vector may be induced by obtaining the maximum depth value by searching depth samples of four corners of respective 8×8-size blocks with respect to a 32×32 block size constituted by sixteen 8×8-size blocks.

In yet another aspect, a method for inducing a disparity vector from a maximum depth value in a depth map associated with a current block in order to replace the unavailable inter-view motion vector when a target reference picture is an inter-view prediction picture at the time of predicting an inter-view motion vector in a 3D picture and an inter-view motion vector of neighboring blocks of the current block is unavailable, includes: inducing the disparity vector by obtaining the maximum depth value by searching a different number of depth samples in the depth map associated with a current block having a predetermined size with respect to the current block having the predetermined size regardless of the size of the current block.

According to a method for inducing a disparity vector in predicting an inter-view motion vector in a 3D picture, when a specific inter-view motion vector of neighboring blocks of a current block is unavailable, a disparity vector is induced by searching a predetermined number of depth samples in the current block, and then obtaining a maximum depth value. As a result, complexity can be significantly improved as compared with a method for inducing the disparity vector by obtaining the maximum depth value with respect to all of N×N depth samples in the current block of an N×N size.

Further, when the specific inter-view motion vector of neighboring blocks of the current block is unavailable, the disparity vector is induced by adaptively searching a different number of depth samples in the corresponding block according to the size of the current bloc, for example, the size of a prediction unit, and then obtaining the maximum depth value. As a result, coding/decoding gain can be increased as compared with a method for searching the depth samples with respect to a fixed block size.

### BRIEF DESCRIPTION OF THE DRAWINGS

FIGS. 1A and 1B are schematic diagrams for describing a method for inducing a disparity vector according to an exemplary embodiment of the present invention.

FIGS. 2A and 2I are schematic diagrams for describing a method for inducing a disparity vector according to another exemplary embodiment of the present invention.

FIG. 3 is a flowchart for describing the method for inducing the disparity vector according to the exemplary embodiment of the present invention.

### DESCRIPTION OF EXEMPLARY EMBODIMENTS

The present invention may have various modifications and various exemplary embodiments and specific exemplary embodiments will be illustrated in the drawings and described in detail.

However, this does not limit the present invention to specific exemplary embodiments, and it should be understood that the present invention covers all the modifications, equivalents and replacements within the idea and technical scope of the present invention.

Terms such as first or second may be used to describe various components but the components are not limited by the above terminologies. The above terms are used only to discriminate one component from the other component. For example, without departing from the scope of the present invention, a second component may be referred to as a first component, and similarly, the first component may be referred to as the second component. A terminology such as and/or includes a combination of a plurality of associated items or any item of the plurality of associated items.

It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, it is understood that no element is not present between the element and the other element.

Terms used in the present application are used only to describe specific exemplary embodiments, and are not intended to limit the present invention. A singular form may include a plural form if there is no clearly opposite meaning in the context. In the present application, it should be understood that term “include” or “have indicates that a feature, a number, a step, an operation, a component, a part or the combination thereof described in the specification is present, but does not exclude a possibility of presence or addition of one or more other features, numbers, steps, operations, components, parts or combinations, in advance.

If it is not contrarily defined, all terms used herein including technological or scientific terms have the same meaning as those generally understood by a person with ordinary skill in the art. Terms which are defined in a generally used dictionary should be interpreted to have the same meaning as the meaning in the context of the related art, and are not interpreted as an ideally or excessively formal meaning unless clearly defined in the present invention.

Hereinafter, a preferable embodiment of the present invention will be described in more detail with reference to the accompanying drawings. In describing the present invention, like reference numerals refer to like elements for easy overall understanding and a duplicated description of like elements will be omitted.

Hereinafter, a coding unit (CU) has a square pixel size, and may have a variable size of 2N2N (unit: pixel). The CU may have a recursive coding unit structure. Inter prediction, intra prediction, transform, quantization, deblocking filtering, and entropy encoding may be configured by a CU unit.

A prediction unit (PU) is a basic unit for performing the inter prediction or the intra prediction.

When 3D video coding is performed based on H.264/AVC, in the case of performing temporal motion vector prediction and inter-view motion vector prediction, if a target reference picture is a temporal prediction picture, temporal motion vectors of neighboring blocks of a current block are used for motion vector prediction. In this case, when the temporal motion vectors are unavailable, a zero vector is used. The temporal motion vector prediction is induced by a median value of motion vectors of neighboring blocks of the current block.

On the other hand, when the 3D video coding is performed based on H.264/AVC or a video coding method of higher-efficiency than H.264/AVC, in the case of performing the inter-view motion vector prediction, if the target reference picture is the inter-view prediction picture, inter-view motion vectors of neighboring blocks of the current block are used for motion vector prediction are used for the inter-view prediction. In this case, when a specific inter-view motion vector of the neighboring blocks is unavailable, a maximum disparity vector transformed (alternatively, induced) from a maximum depth value in the depth block (alternatively, a depth map) related to the current block is used instead of the unavailable specific inter-view motion vector. In addition, the inter-view motion vector prediction may be induced by the median value of the inter-view motion vectors of the neighboring blocks of the current block like the motion vector prediction of existing H.264/AVC.

As such, when the 3D video coding is performed based on H.264/AVC or a video coding method of higher-efficiency than H.264/AVC, in the case where the specific inter-view motion vector of the neighboring blocks of the current block is unavailable as described above, in order to obtain the maximum disparity vector (DV) by using the maximum depth value in the depth block (alternatively, a depth map), for example, in the case where the PU is a 16×16 macroblock, since 256 depth samples need to be searched, 255 comparison operations need to be performed and calculation thereof is very complicated. Accordingly, in this case, as a simpler method of inducing the disparity vector, the maximum disparity vector is induced by searching only K depth samples-for example, as K=4, four depth samples of 16×16 macroblock corner-instead of 256 depth samples, and then obtaining a maximum depth value. By the simplification, the number of depth samples to be accessed is largely reduced from 256 to 4, and the number of required comparisons is largely reduced from 255 to 3.

According to the exemplary embodiment of the present invention, when the 3D video coding is performed based on H.264/AVC or a video coding method of higher-efficiency than H.264/AVC, according to the size (for example, 16×16, 64×64, or 32×32 pixels) of the PU, the maximum disparity vector is induced by adaptively searching only K-for example, K is a positive integer of 4, 16, 32, 60, 61, 74, and 90-depth samples, and obtaining the maximum depth value.

Particularly, when considering a case of using a block size of 32×32 pixels and 64×64 pixels which is larger than 16×16 macroblocks of H.264/AVC as a coding unit or a prediction unit, in the case where the specific inter-view motion vectors of the neighboring blocks of the current block are unavailable, in order to obtain the maximum disparity vector (DV) by using the maximum depth value in the depth block (alternatively, the depth map), all depth samples of 32×32 and 64×64 need to be searched, and as a result, this process is very complicated. Accordingly, in this case, the maximum disparity vector is induced by adaptively searching only a different number of depth samples according to a block size-for example, a size of the PU-instead of all of the depth samples of 32×32 and 64×64, and then obtaining a maximum depth value. As a result, coding/decoding gain can be increased.

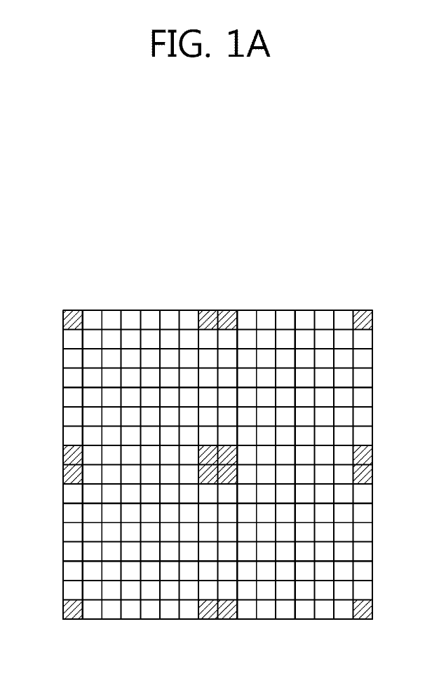

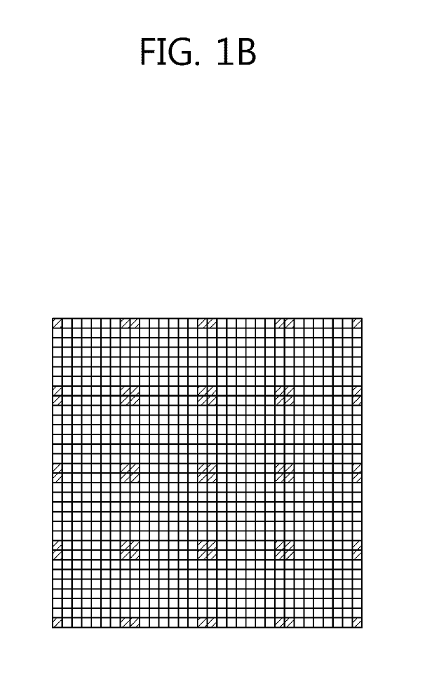

FIGS. 1A and 1B are schematic diagrams for describing a method for inducing a disparity vector by adaptively searching only a different number of depth samples in a corresponding block depending on a block size according to an exemplary embodiment of the present invention.

Referring to FIG. 1A, with respect to a size of a 16×16 block constituted by four blocks having an 8×8 size, the maximum disparity vector is induced by searching depth samples of four corners of each block with the 8×8 size, that is, the depth samples of a total of 16 corners, and then obtaining the maximum depth value.

Referring to FIG. 1B, with respect to a size of a 32×32 block constituted by 16 blocks having an 8×8 size, the maximum disparity vector is induced by searching depth samples of four corners of each block with the 8×8 size, that is, the depth samples of a total of 64 corners, and then obtaining the maximum depth value.

Meanwhile, according to anther exemplary embodiment of the present invention, when the 3D video coding is performed based on H.264/AVC or a video coding method of higher-efficiency than H.264/AVC, regardless of a size of the PU (for example, a 16×16, 64×64, or 32×32 pixel), the maximum depth value is induced by searing only a different number (K1, K2, K3, . . . ) of depth samples with respect to a block having a predetermined size, and then obtaining the maximum depth value.

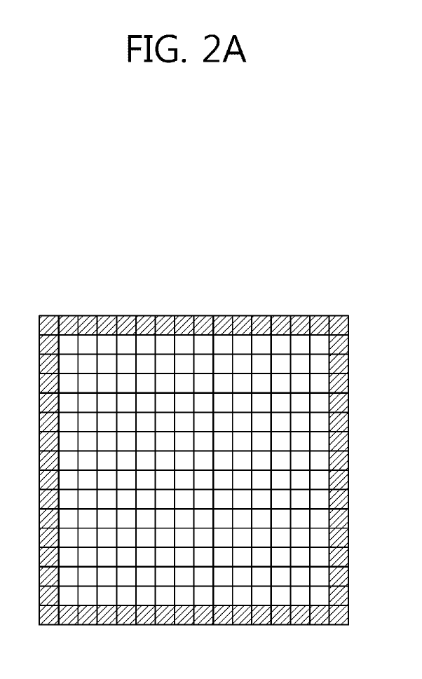

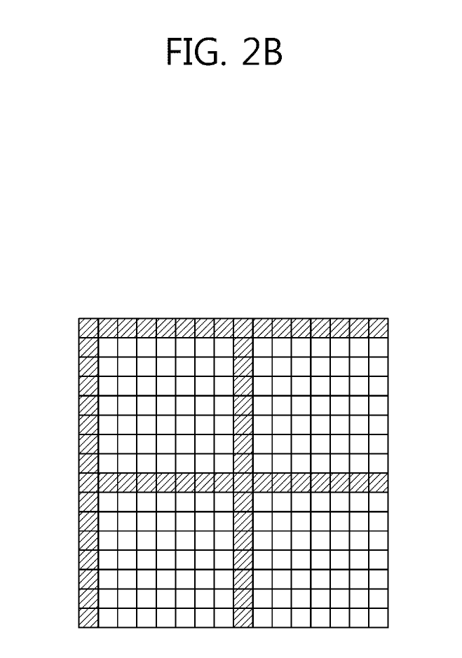

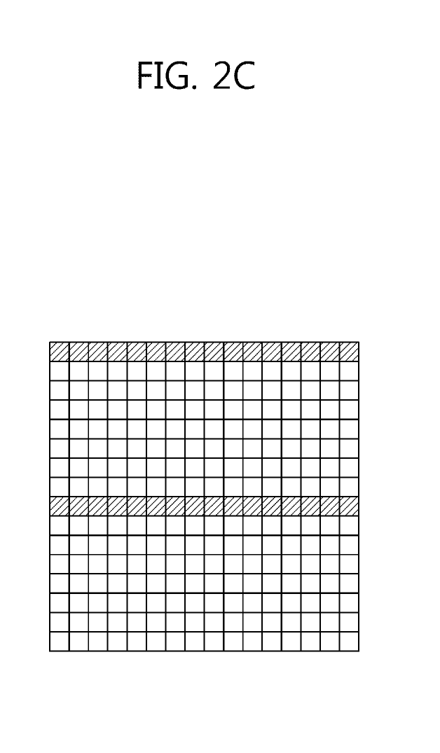

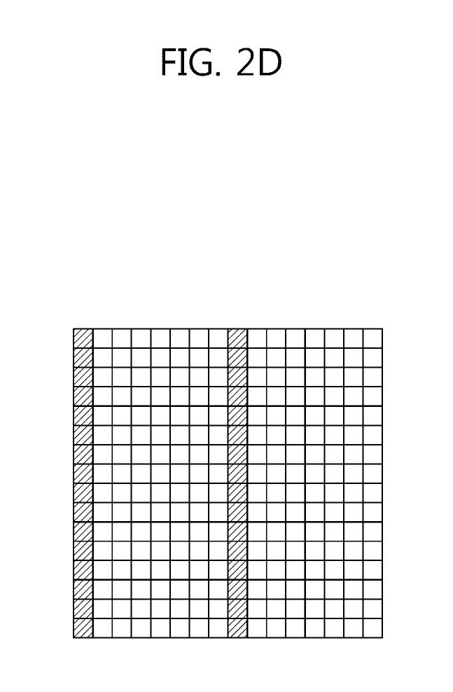

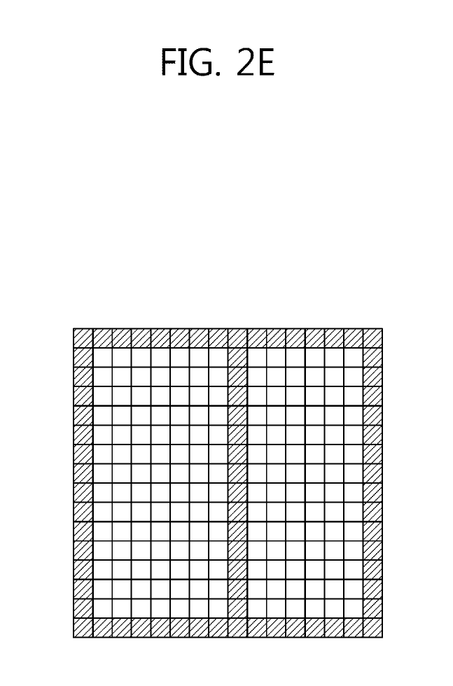

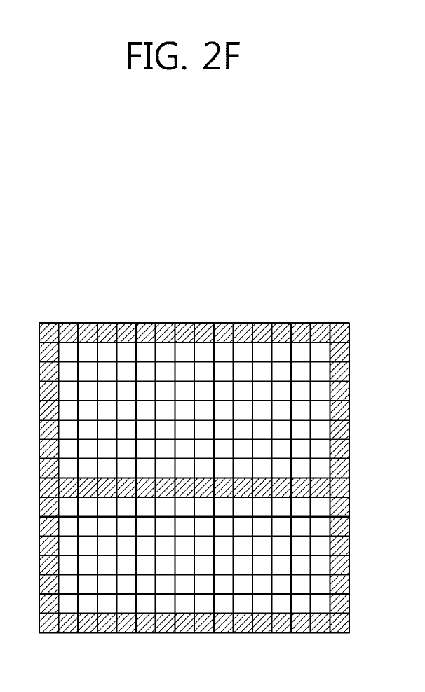

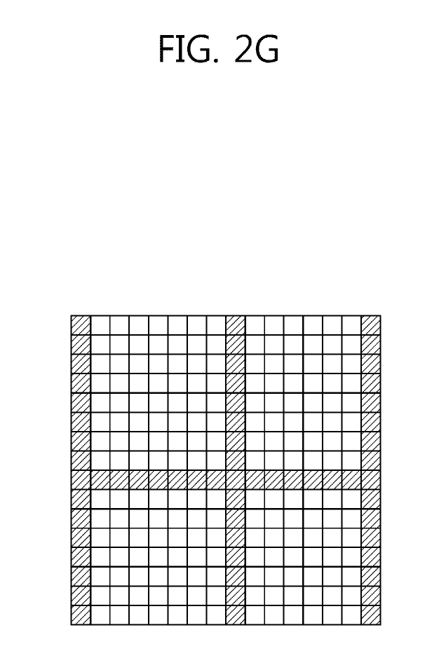

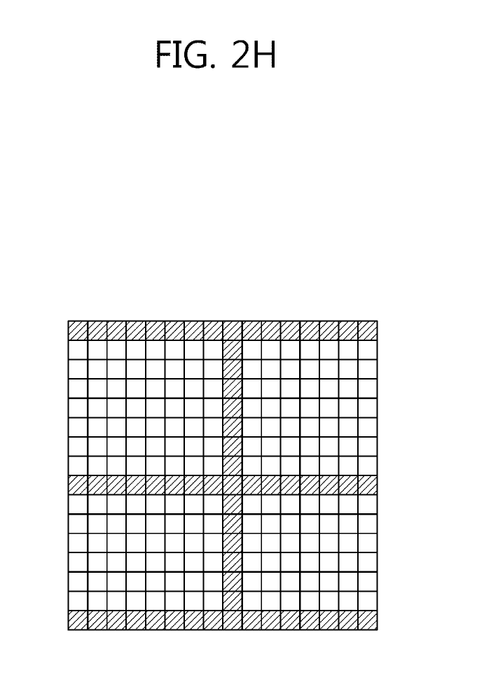

FIGS. 2A to 2I are schematic diagrams for describing a method for inducing a disparity vector by searching only a different number of depth samples in a corresponding block with respect to a block having a predetermined size regardless of a size of a block according to another exemplary embodiment of the present invention.

Referring to FIGS. 2A to 2I, a maximum disparity vector may be induced by searching a different number of depth samples in each block with respect to a block having a predetermined size of 16x16, and then obtaining a maximum depth value.

Hereinafter, a position x in an X-axial direction and a position y in a y-axial direction are represented by (x,y).

Referring to FIG. 2A, depth samples corresponding to four edges are searched with respect to a 16×16 block. That is, the disparity vector may be induced by searching only depth samples corresponding to x=1 and y=1 to 16, depth samples corresponding to x=16 and y=1 to 16, depth samples corresponding to x=1 to 16 and y=1, depth samples corresponding to x=1 to 16 and y=16, a total of 60 depth samples, and then obtaining the maximum depth value.

Referring to FIG. 2B, with respect to the 16×16 block, the disparity vector may be induced by searching only depth samples corresponding to x=1 and y=1 to 16, depth samples corresponding to x=9 and y=1 to 16, depth samples corresponding to x=1 to 16 and y=1, depth samples corresponding to x=1 to 16 and y=9, a total of 60 depth samples, and then obtaining the maximum depth value.

Referring to FIG. 2C, with respect to the 16x16 block, the disparity vector may be induced by searching only depth samples corresponding to x=1 and y=1 to 16, depth samples corresponding to x=9 and y=1 to 16, and a total of 30 depth samples, and then obtaining the maximum depth value.

Referring to FIG. 2D, with respect to the 16×16 block, the disparity vector may be induced by searching only depth samples corresponding to x=1 to 16 and y=1, depth samples corresponding to x=1 to 16 and y=9, and a total of 32 depth samples, and then obtaining the maximum depth value.

Referring to FIG. 2E, depth samples corresponding to four edges and a center are searched with respect to a 16×16 block. That is, the disparity vector may be induced by searching only depth samples corresponding to x=1 and y=1 to 16, depth samples corresponding to x=9 and y=1 to 16, depth samples corresponding to x=16 and y=1 to 16, and a total of 72 depth samples, and then obtaining the maximum depth value.

Referring to FIG. 2F, depth samples corresponding to four edges and a center are searched with respect to a 16×16 block. That is, the disparity vector may be induced by searching only depth samples corresponding to x=1 and y=1 to 16, depth samples corresponding to x=1 to 16 and y=9, depth samples corresponding to x=1 to 16 and y=1, depth samples corresponding to x=1 to 16 and y=16, a total of 74 depth samples, and then obtaining the maximum depth value.

Referring to FIG. 2G, with respect to the 16×16 block, the disparity vector may be induced by searching only depth samples corresponding to x=1 and y=1 to 16, depth samples corresponding to x=1 to 16 and y=9, depth samples corresponding to x=1 to 16 and y=16, depth samples corresponding to x=1 to 16 and y=9, a total of 61 depth samples, and then obtaining the maximum depth value.

Referring to FIG. 2H, with respect to the 16×16 block, the disparity vector may be induced by searching only depth samples corresponding to x=1 and y=1 to 16, depth samples corresponding to x=1 to 16 and y=9, depth samples corresponding to x=1 to 16 and y=16, depth samples corresponding to x=9 and y=1 to 16, a total of 61 depth samples, and then obtaining the maximum depth value.

Referring to FIG. 2I, depth samples corresponding to four edges and a center are searched with respect to a 16×16 block. That is, the disparity vector may be induced by searching only depth samples corresponding to x=1 and y=1 to 16, depth samples corresponding to x=9 and y=1 to 16, depth samples corresponding to x=16 and y=1 to 16, depth samples corresponding to x=1 to 16 and y=1, depth samples corresponding to x=1 to 16 and y=9, depth samples corresponding to x=1 to 16 and y=16, a total of 90 depth samples, and then obtaining the maximum depth value.

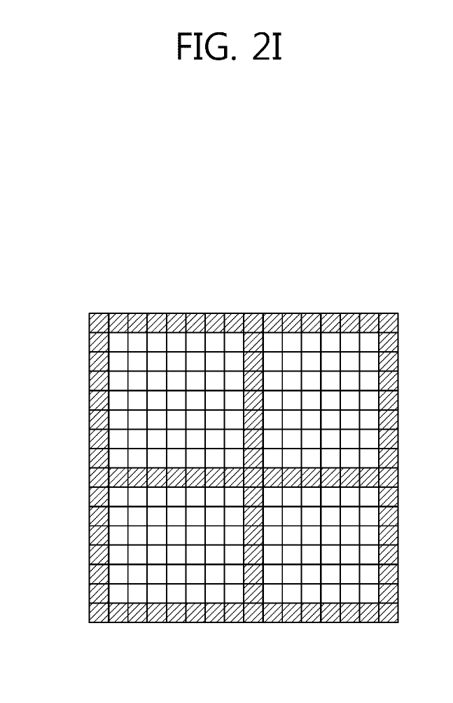

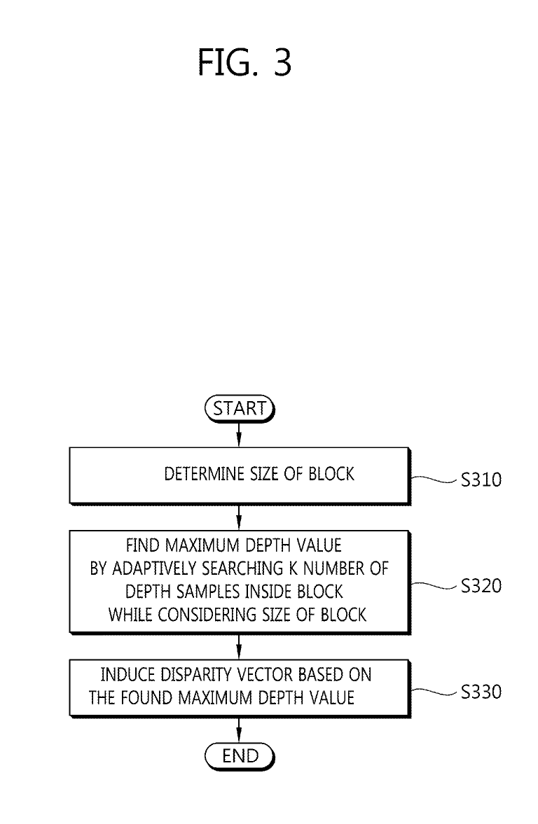

FIG. 3 is a flowchart for describing the method for inducing the disparity vector according to the exemplary embodiment of the present invention.

Referring to FIG. 3, when the 3D video coding is performed based on H.264/AVC or a video coding method of higher-efficiency than H.264/AVC, first, a size (for example, 16×16, 64×64, or 32×32 pixels) of a block—for example, a PU—is determined (S310), only K—for example, K is a positive integer of 4, 16, 32, 60, 61, 74, and 90-depth samples are adaptively searched to obtain a maximum depth value (S320) by considering the size of the block, and the disparity vector is induced based on the found maximum depth value (S330).

While the invention has been shown and described with respect to the preferred embodiments, it will be understood by those skilled in the art that various changes and modifications may be made without departing from the spirit and scope of the invention as defined in the following claims.

What is claimed is:

1. A method for inducing a disparity vector from a maximum depth value in a depth map associated with a current block in order to replace the unavailable inter-view motion vector when a target reference picture is an inter-view prediction picture at the time of predicting an inter-view motion vector in a 3D picture and an inter-view motion vector of neighboring blocks of the current block is unavailable, the method comprising:
inducing the disparity vector by obtaining the maximum depth value by searching a predetermined number of depth samples in the depth map associated with the current block with respect to the current block.

2. The method of claim 1, wherein a maximum disparity vector is induced by obtaining the maximum depth value by searching depth samples of four corners of respective 8×8-size blocks with respect to a 16×16 block size constituted by four 8×8-size blocks.

3. The method of claim 1, wherein the maximum disparity vector is induced by obtaining the maximum depth value by searching depth samples of four corners of respective 8×8-size blocks with respect to a 32×32 block size constituted by sixteen 8×8-size blocks.

4. A method for inducing a disparity vector from a maximum depth value in a depth map associated with a current block in order to replace the unavailable inter-view motion vector when a target reference picture is an inter-view prediction picture at the time of predicting an inter-view motion vector in a 3D picture and an inter-view motion vector of neighboring blocks of the current block is unavailable, the method comprising:
inducing the disparity vector by obtaining the maximum depth value by searching adaptively a different number of depth samples in the depth map associated with the current block according to the size of the current block.

5. The method of claim 4, wherein a maximum disparity vector is induced by obtaining the maximum depth value by adaptively searching only K—K is a positive integer—depth samples according to the size of a prediction unit (PU).

6. The method of claim 4, wherein a maximum disparity vector is induced by obtaining the maximum depth value by searching depth samples of four corners of respective 8×8-size blocks with respect to a 16×16 block size constituted by four 8×8-size blocks.

7. The method of claim 4, wherein the maximum disparity vector is induced by obtaining the maximum depth value by searching depth samples of four corners of respective 8×8-size blocks with respect to a 32×32 block size constituted by sixteen 8×8-size blocks.

8. A method for inducing a disparity vector from a maximum depth value in a depth map associated with a current block in order to replace the unavailable inter-view motion vector when a target reference picture is an inter-view prediction picture at the time of predicting an inter-view motion vector in a 3D picture and an inter-view motion vector of neighboring blocks of the current block is unavailable, the method comprising:
inducing the disparity vector by obtaining the maximum depth value by searching a different number of depth samples in the depth map associated with a current block having a predetermined size with respect to the current block having the predetermined size regardless of the size of the current block.
